(19) United States
(12) Patent Application Publication
(10) Pub. No.: US 2004/0219910 A1
(43) Pub. Date: Nov. 4, 2004

(54) Method and system for supplying information in relation with position occupied by a user in a site

(76) Inventor: Fabien Beckers, Paris (FR)

Correspondence Address: RATNERPRESTIA, P O BOX 980, VALLEY FORGE, PA, 19482-0980, US

(21) Appl. No.: 10/479,023

(22) PCT Filed: May 24, 2002
(86) PCT No.: PCT/FR02/01756

(30) Foreign Application Priority Data
May 25, 2001 (FR) 01/06883

(51) Int. Cl. H04Q 7/00

(52) U.S. Cl. 455/422.1

(57) ABSTRACT

The present invention pertains to a method, a system, a server, a portable device and chips which are used to supply information (I) contained in a database (12) in relation to the position occupied by a user in a site. The method comprises the steps: for a portable device (3, 4), of receiving, from chips (5), data specific to said chips (5), correlated with the information (I); of establishing, via a communication network (8), a connection between the portable device (3, 4) and a server (7) associated with the database (12); of communicating the specific data to the server (7); of seeking the information (I) in the database (12); of transmitting the information (I) to the portable device (3, 4), via the communication network (8); for the portable device (3, 4), of sending the information (I), the contents of which are correlated with the specific data, to the user (1).

The present invention pertains to a method, a system, a server, a portable device and chips for supplying information in relation to the position occupied by a user in a site.

Method

The present invention pertains to a method for supplying information (I) to a user at defined points of a site. The user has a mobile telephone transmit-receive portable device.

The method comprises the step, for the mobile telephone transmit-receive portable device, of receiving, from chips arranged appropriately inside the site, data specific to the chips.

The contents of the information (I) are correlated with specific data in a database containing the information (I). The method additionally comprises:

the step, for the mobile telephone transmit-receive portable device, of establishing, via a communication network, a connection with a server, especially of the internet type, associated with the database,

the step, for the mobile telephone transmit-receive portable device, of communicating the specific data to the server, via the communication network, the step, for the server, of seeking the information (I) in the database, the contents of which are correlated with the specific data,

the step, for the server, of transmitting to the mobile telephone transmit-receive portable device, via the communication network, the information (I), the contents of which are correlated with the specific data,

the step, for the mobile telephone transmit-receive portable device, of sending to the user the information (I), the contents of which are correlated with the specific data.

The user thus has access to information (I) associated with the specific data of the chips, particularly located in proximity to the place in which he finds himself.

Preferably, according to the present invention the information (I) is sought in the database as a function of additional data supplied by the user.

Preferably, according to the present invention the method additionally comprises the step, for the mobile telephone transmit-receive portable device, of loading and/or downloading the information (I) in a database integrated with the mobile telephone transmit-receive portable device.

Preferably, according to the present invention the method additionally comprises the step, for the transmit-receive portable device, of downloading the information (I), at at least one defined point of the site, in the database integrated with the portable device.

Preferably, according to the present invention the method comprises the step, for the transmit-receive portable device, of additionally seeking, in the integrated database, the information (I), the contents of which are correlated with the specific information received from the chips, and if need be, with the additional information.

Preferably, according to the present invention the method additionally comprises the step, for the mobile telephone transmit-receive portable device, of sending the information (I), the contents of which are correlated with the specific data and, if need be, with the additional data, to the user.

Preferably, according to the present invention the method is such that the information is sent by the mobile telephone transmit-receive portable device to the user via a text and/or graphic and/or audio message.

Preferably, according to the present invention the method is such that the information is sent by the mobile telephone transmit-receive portable device to the user, via a video message appearing on a display screen associated with the mobile telephone transmit-receive portable device.

Preferably, according to the present invention the method is such that the information is sent by the mobile telephone transmit-receive portable device to the user via a tactile message produced by a tactile, mobile element, actuated by the mobile telephone transmit-receive portable device.

Preferably, according to the present invention the method comprises the step, for the user, of actuating a control unit of the mobile telephone transmit-receive portable device for extracting and/or picking up the specific data from the chips.

Preferably, according to the present invention the method comprises the step, for the mobile telephone transmit-receive portable device, of extracting and/or of automatically picking up the specific data from the chips when the user passes in proximity to these.

Preferably, according to the present invention the method is more particularly intended for supplying data relative to the site. In the case of this embodiment variant, the method additionally comprises:

the step, for the user, of entering in the mobile telephone transmit-receive portable device data relative to the type of information that he is seeking inside the site,

the step, for the chips, of supplying the specific data relative to the type of information accessible in the zones in which the chips are located,

the step, for the mobile telephone transmit-receive mobile telephone transmit-receive portable device receiving the specific data from the chips located in proximity, of sending a message to the user, informing him that he is in a zone of the site in which he may find the type of information that he is seeking.

System

The present invention pertains to a system for supplying information (I) to a user at defined points of a site. The system comprises a mobile telephone transmit-receive portable device put at the disposal of a user.

The mobile telephone transmit-receive portable device comprises first receiving means for receiving, from chips arranged appropriately inside the site, data specific to the chips.

The contents of the information (I) are correlated with the specific data. The system additionally comprises:

a database containing the information (I),

a server, particularly of the internet type, associated with the database.

The mobile telephone transmit-receive portable device comprises:

first communication means for establishing, via a communication network, a connection with the server and the database,

first transmission means for communicating the specific data to the server via the communication network.

The server comprises:

computing means for seeking the information (I), the contents of which are correlated with the specific data, in the database,

second communication means for transmitting the information (I), the contents of which are correlated with the specific data, to the mobile telephone transmit-receive portable device, via the communication network.

The mobile telephone transmit-receive portable device comprises first sending means for sending the information (I), the contents of which are correlated with the specific data, to the user.

The user thus has access to the information (I) associated with the specific data of the chips, particularly located in proximity to the place in which he finds himself.

Preferably, according to the present invention the information (I) is sought in the database as a function of additional data supplied by the user.

Preferably, according to the present invention the mobile telephone transmit-receive portable device comprises an integrated database.

The system additionally comprises loading and/or downloading means for loading and/or downloading the information (I) into the integrated database.

Preferably, according to the present invention the system additionally comprises loading and/or downloading means for loading and/or downloading the information (I) into the integrated database at at least one defined point of the site.

Preferably, according to the present invention the transmit-receive portable device comprises second computing means for additionally seeking, in the integrated database, the information (I), the contents of which are correlated with the specific information received from the chips, and if need be, with the additional information.

Preferably, according to the present invention the mobile telephone transmit-receive portable device additionally comprises second sending means for sending to the user the information (I) that comes from the integrated database, the contents of which are correlated with the specific data and, if need be, with the additional data.

Preferably, according to the present invention the system is such that the information (I) is sent by the first sending means and/or the second sending means of the mobile telephone transmit-receive portable device, to the user, via a text and/or graphic and/or audio message.

Preferably, according to the present invention the system is such that the information (I) is sent by the first sending means and/or the second sending means of the mobile telephone transmit-receive portable device, to the user, via a video message appearing on a display screen associated with the mobile telephone transmit-receive portable device.

Preferably, according to the present invention the system is such that the information (I) is sent by the first sending means and/or the second sending means of the mobile telephone transmit-receive portable device, to the user, via a tactile message produced by a tactile, mobile element, actuated by the mobile telephone transmit-receive portable device.

Preferably, according to the present invention the mobile telephone transmit-receive portable device comprises:

a first control unit actuatable by the user,

first data processing means actuated by the control unit for extracting and/or picking up the specific data from the chips.

Preferably, according to the present invention the mobile telephone transmit-receive portable device comprises second data processing means for extracting and/or for automatically picking up the specific data from the chips when the user passes in proximity to these.

Preferably, according to the present invention the system is more particularly intended for supplying data relative to the site. The system is such that the mobile telephone transmit-receive portable device additionally comprises first data entry means, particularly a control unit comprises a keyboard, actuatable by the user, for entering data relative to the type of information that he is seeking inside the site in the mobile telephone transmit-receive portable device.

The mobile telephone transmit-receive portable device comprises:

first detection means for detecting and picking up the specific data, from the chips, relative to the type of information accessible in the zones in which the chips are located,

third sending means for sending a message to the user, informing him that he is in a zone of the site in which he may find the type of information that he is seeking. Server

The present invention pertains to a server for supplying information (I) to a user at defined points of a site. The server cooperating [sic, cooperates—Tr.Ed.] with a mobile telephone transmit-receive portable device, used by a user, for receiving, from chips arranged appropriately inside the site, data specific to the chips.

The contents of the information (I) are correlated with the specific data in a database containing the information (I). The server is associated with the database. The server comprises connection means for establishing, via a communication network, particularly of the internet type, a connection with the mobile telephone transmit-receive portable device.

The server comprises second receiving means for receiving the specific data from the mobile telephone transmit-receive portable device, via the communication network.

computing means for seeking the information (I), the contents of which are correlated with the specific data, in the database,

second communication means for transmitting the information (I), the contents of which are correlated with the specific data, to the mobile telephone transmit-receive portable device, via the communication network.

Preferably, according to the present invention the information (I) is sought in the database as a function of additional data supplied by the user.

Mobile Telephone Transmit-Receive Portable Device

The present invention also pertains to a mobile telephone transmit-receive portable device.

The mobile telephone transmit-receive portable device, placed at the disposal of a user, is intended to supply, to the user, information (I) contained in a database, at defined points of a site.

The mobile telephone transmit-receive portable device comprises first receiving means for receiving, from chips arranged appropriately inside the site, data specific to the chips.

The contents of the information (I) are correlated with the specific data. The mobile telephone transmit-receive portable device additionally comprises:

first communication means for establishing, via a communication network, a connection with the database,

first transmission means for communicating the specific data to a server associated with the database, via the communication network.

third receiving means for receiving from the server, via the communication network, the information (I), the contents of which are correlated with the specific data,

first sending means for sending the information (I), the contents of which are correlated with the specific data, to the user.

The user thus has access to the information (I) associated with the specific data of the chips, particularly located in proximity to the place in which he finds himself.

Preferably, according to the present invention the information (I) is sought in the database as a function of additional data supplied by the user to the mobile telephone transmit-receive portable device.

Preferably, according to the present invention the mobile telephone transmit-receive portable device comprises an integrated database, in which the information (I) can be loaded and/or downloaded into the integrated database.

Preferably, according to the present invention the mobile telephone transmit-receive portable device comprises an integrated database, in which the information (I) can be loaded and/or downloaded at at least one defined point of the site.

Preferably, according to the present invention the transmit-receive portable device comprises second computing means for additionally seeking, in the integrated database, the information (I), the contents of which are correlated with the specific information received from the chips, and if need be, with the additional information.

Preferably, according to the present invention the mobile telephone transmit-receive portable device additionally comprises second sending for sending to the user the information (I), from the integrated database, the contents of which are correlated with the specific data and, if need be, with the additional data.

Preferably, according to the present invention the information (I) is sent by the first sending means and/or the second sending means of the mobile telephone transmit-receive portable device, to the user, via a text and/or graphic and/or audio message.

Preferably, according to the present invention the information (I) is sent by the first sending means and/or the second sending means of the mobile telephone transmit-receive portable device, to the user, via a video message appearing on a display screen associated with the mobile telephone transmit-receive portable device.

Preferably, according to the present invention the information (I) is sent by the first sending means and/or the second sending means of the mobile telephone transmit-receive portable device, to the user, via a tactile message produced by a tactile, mobile element, actuated by the mobile telephone transmit-receive portable device.

Preferably, according to the present invention the mobile telephone transmit-receive portable device comprises

a first control unit actuatable by the user,

first data processing means actuated by the control unit for extracting and/or picking up the specific data from the chips.

Preferably, according to the present invention the mobile telephone transmit-receive portable device comprises second data processing means for extracting and/or for automatically picking up the specific data from the chips when the user passes in proximity to these.

Preferably, according to the present invention the mobile telephone transmit-receive portable device is more particularly intended to supply data relative to the site.

The mobile telephone transmit-receive portable device additionally comprises first data entry means, particularly a control unit comprises a keyboard, actuatable by the user, for entering data relative to the type of information that he is seeking inside the site in the mobile telephone transmit-receive portable device.

The mobile telephone transmit-receive portable device comprises:

first detection means for detecting and picking up the specific data, from the chips, relative to the type of information accessible in the zones in which the chips are located,

third sending means for sending a message to the user, informing him that he is in a zone of the site in which he may find the type of information that he is seeking.

Chip

The present invention pertains to a chip for supplying information (I) to a user at defined points of a site. The chip is intended to be arranged appropriately inside the site. The chip containing the specific data. The contents of the information (I) are correlated with the specific data. The specific data are intended to be picked up by a mobile telephone transmit-receive device used by the user.

The mobile telephone transmit-receive portable device comprises first sending means for sending the information (I), the contents of which are correlated with the specific data, to the user.

Preferably, according to the present invention the mobile telephone transmit-receive portable device comprises remote chip activation means.

The chip comprises second transmission means transmitting the specific data when it is activated by the mobile telephone transmit-receive portable device.

Preferably, according to the present invention the mobile telephone transmit-receive portable device comprises a first control unit, actuatable by the user and triggering the remote chip activation means.

Preferably, according to the present invention the chip comprises a source of energy, and in particular a battery, feeding the (second) transmission means.

Preferably, according to the present invention the source of energy consists of a converter of electromagnetic energy and/or light energy.

Preferably, according to the present invention the electromagnetic energy or the light energy is supplied by the mobile telephone transmit-receive portable device, and particularly via infrared radiation.

### DETAILED DESCRIPTION

Other features and advantages of the present invention will become evident from the reading of the description of embodiment variants of the present invention given by way of indicative and nonlimiting example and of

FIG. 1, which shows an overall schematic view of an embodiment variant of the system and method according to the present invention,

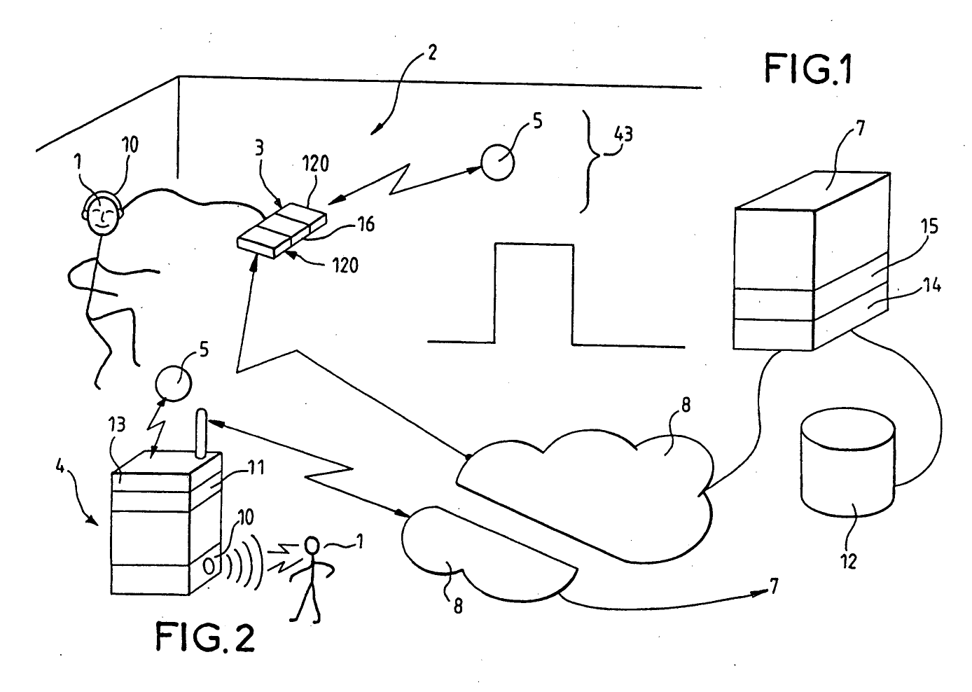

FIG. 2, which shows an embodiment variant in the case in which the transmit-receive portable device is a mobile telephone,

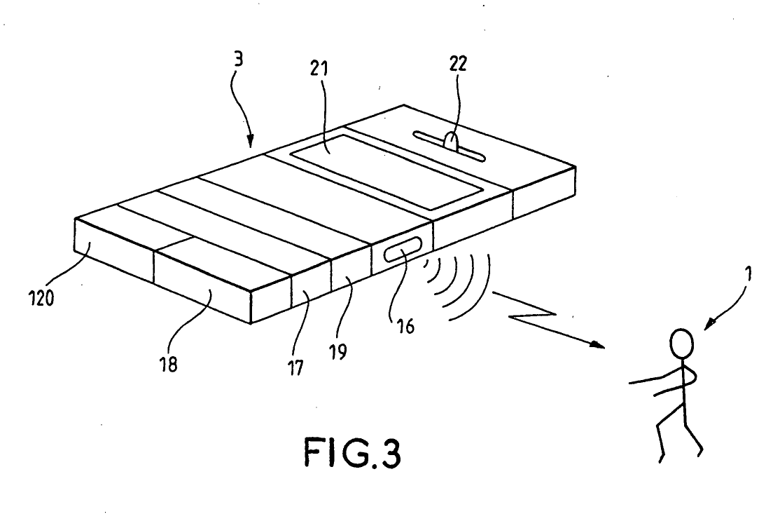

FIG. 3, which shows an embodiment variant of a portable transmit-receive device comprising an integrated database,

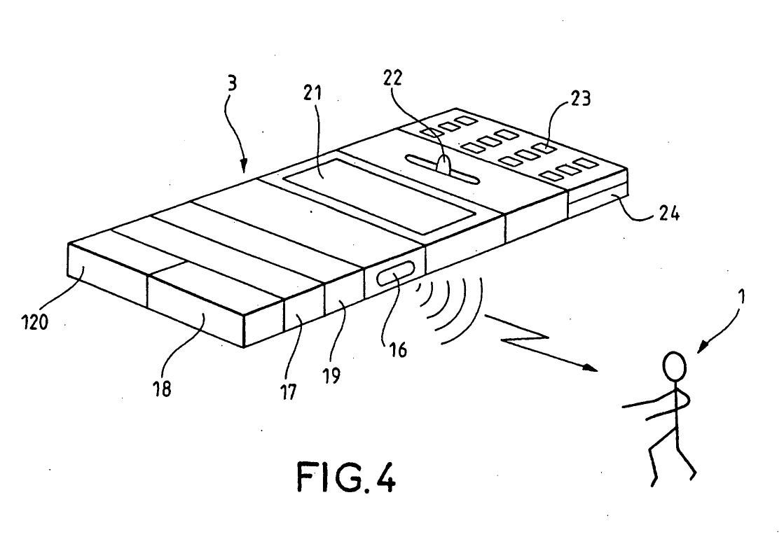

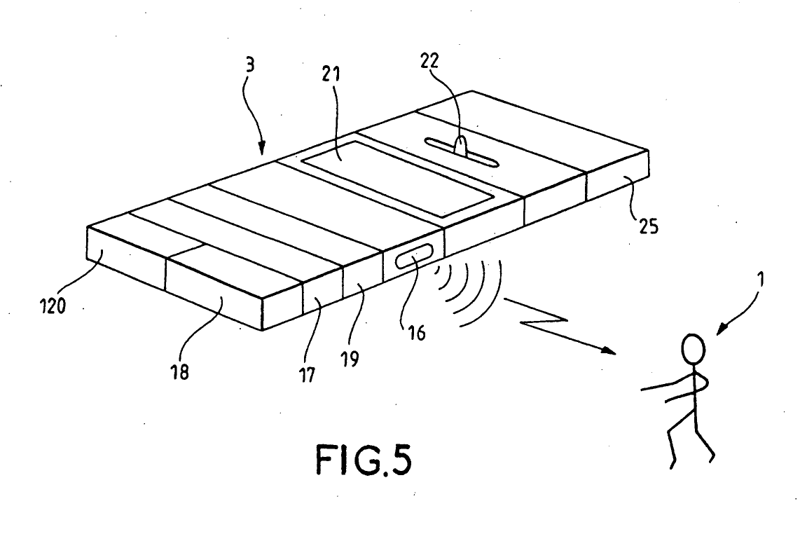

FIG. 4, which shows an embodiment variant of a portable transmit-receive device comprising a control unit,

FIG. 5, which shows an embodiment variant of a portable transmit-receive device, passive, receiving broadcast information,

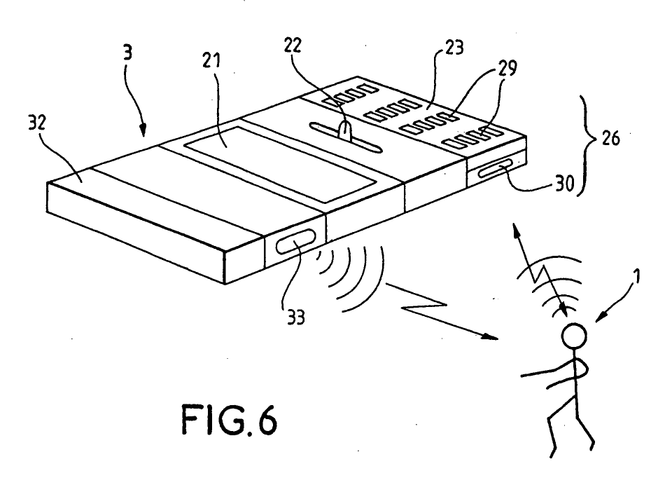

FIG. 6, which shows an embodiment variant of a portable transmit-receive device, active, enabling a user to seek information in a site.

The present invention pertains to a system for supplying information (I) to a user 1 at defined points of a site 2. In general, the information (I) is relative to the site 2 or to its contents, as this will be described below.

The system comprises a transmit-receive portable device 3, particularly a mobile telephone 4, used by the user 1 for receiving from chips 5 arranged appropriately inside the site 2 data specific to the chips 5. The contents of the information (I) are correlated with the specific data. The chips 5 are preferably arranged in visible places, in which, in a manner known per se, the transmission shall be optimized both from a technical point of view as well as from the point of view of the user. The transmission is carried out as follows: The mobile telephone transmit-receive portable device 3, 4 transmits, in a manner known per se, an electromagnetic wave comprising a signal via the bias of appropriate electronic circuits comprising an oscillator. The chip 5 is activated by the incident wave. The signal is recognized, in a manner known per se, as the suitable signal by the electronic circuits comprising a resonator located inside the chip. The chip sends an electromagnetic wave in return via the bias of appropriate electronic circuits comprising an oscillator to the mobile telephone transmit-receive portable device 3, 4 (in particular, to a mobile telephone). This electromagnetic wave comprises a code containing data specific to the chip in question. The mobile telephone transmit-receive portable device 3, 4 receives, via the bias of its antenna, the specific data and interprets these according to an established and predetermined protocol. In the case of the embodiment variant described variant, the protocol for transmitting the specific data is carried out by using a “bluetooth” protocol, which is capable of generating a wave according to the terms of this particular protocol. This “bluetooth” component may have its own power supply.

The information (I) can be supplied by a remote server 7 connected, via a communication network 8, to the mobile telephone transmit-receive portable device 3, 4. The mobile telephone transmit-receive portable device 3, 4 comprises third receiving means 53 for receiving information (I) from the server 7. In another embodiment variant, the information (I) can also be supplied by a database 120 integrated with the mobile telephone transmit-receive portable device 3, 4. These two embodiment variants are not exclusive from one another, and it will be seen that, in some embodiment variants, the information (I) can come from a remote server 7 and from a database 120 integrated with the mobile telephone transmit-receive portable device 3, 4. In particular, in the case of a museum, and according to one embodiment variant, the information (I) is downloaded into the database 120 at the entrance. The information (I) is then sent upon the passing of the user 1 in front of each displayed work equipped with a chip 5. In the case of another embodiment variant the user 1, looking in front of a displayed work equipped with a chip 5, addresses a request to the server 7 by means of the mobile telephone transmit-receive portable device 3, 4. In response, the server 7 also transmits the information (I) specific to this request.

The mobile telephone transmit-receive portable device 3, 4 additionally comprises first sending means 10 for sending the information (I), the contents of which are correlated with the specific data, to the user 1. The mobile telephone transmit-receive portable device 3, 4 may be a personal assistant equipped with a connection to a telephone network and the first sending means 10 may consist of headphones or a loudspeaker. It shall be seen below in what ways it is possible to send the information (I) to the user.

The user 1, visiting a museum, such as the Louvre, and passing in proximity to paintings equipped with chips 5, can receive information relative to these paintings, if need be, via an internet server 7 or via an intranet dedicated server 7.

The user 1 has access to information in relation to the specific data of the chips 5 and, more particularly, in relation to the specific data of the chips 5 located in a zone 43 located in proximity to the place in which he finds himself. The signals from the chips 5 have a short propagation distance (about a few dozen meters); therefore, the user has access to information in relation to the specific data of the chips 5 located in proximity to the place in which he finds himself. He may receive information information in relation to the specific data of a plurality of chips 5 or of only one chip 5.

The particular embodiment variant which corresponds to the case in which the server 7 is associated with a mobile telephone 4 will now be described in greater detail, by referring to FIG. 2. The case in which the transmit-receive portable device 3 is a mobile telephone 4 is, actually, a preferential embodiment variant of the present invention. The mobile telephone 4 comprises, in a manner known per se, first communication means 11 for establishing, via a communication network 8, a connection with a server 7, particularly of the internet type. The mobile telephone comprises a “bluetooth” type link with the chips 5, as this was described above. The server 7 (see FIG. 1) is associated with a database 12 containing the information (I). The mobile telephone 4 additionally comprises first transmission means 13, known per se, for communicating the specific data and, if need be, the additional data supplied by the user 1 to the server 7, via the communication network 8. The server 7 comprises first computing means 14 for seeking the information (I), the contents of which are correlated with the specific data and, if need be, with the additional data, in the database 12. The server 7 additionally comprises second communication means 15 for transmitting the information (I), the contents of which are correlated with the specific data and, if need be, with the additional data, to the mobile telephone 4 via the communication network 8. The mobile telephone 4 comprises first sending means 10 for sending the information (I), the contents of which are correlated with the specific data and, if need be, with the additional data, to the user 1.

The particular case of a database 120 integrated in a specific transmit-receive portable device 3 will now be described in greater detail, by referring to FIG. 3. In this case, the transmit-receive portable device 3 comprises downloading means 17 for downloading the information (I), particularly at the entrance of the site 2, into a database 120 associated with the transmit-receive portable device 3, particularly into a voice mailbox 18. The transmit-receive portable device 3 additionally comprises second computing means 19 for seeking the information (I), the contents of which are correlated with the specific data and, if need be, with the additional data, in the associated database 120. The transmit-receive portable device 3 additionally comprises second sending means 16 for sending the information (I), the contents of which are correlated with the specific data and, if need be, with the additional data, to the user 1. It shall be seen below in what way the information (I) can be sent to the user 1.

The result of the combination of the technical features is that the user 1 has access to the information (I) in relation to the specific data of the chips 5 and, more particularly, in relation to the specific data of the chips 5 located in proximity to the place in which he finds himself. The result of the combination of the technical features is also that, for example, the user 1 can, at the entrance of the section of a museum, such as the Egypt section of the Louvre, download a set of voice messages corresponding to the section and listen to these at the time of his passing in proximity to the chips 5 associated with the works put on display in the museum. Thus, it is possible to reduce the communication time with an internet type network.

How the information (I) is sent to the user 1 shall now be described.

In the case of a first embodiment variant, the information is sent by the transmit-receive portable device 3, particularly by the mobile telephone 4, to the user 1, via a text and/or graphic and/or audio message.

In the case of another embodiment variant (see FIG. 3), the information is sent by the transmit-receive portable device 3, particularly by the mobile telephone 4, to the user 1, via a video message appearing on a display screen 21 associated with the transmit-receive portable device 3. The result of the combination of the technical features is that, for example, if the user 1 has a mobile telephone 4 according to the UMTS or GPRS standard, he may log on to a server 7 and download, from this server 7, video sequences containing information particularly relative to the different means, making it possible to procure, purchase and have delivered a product shown in an exposition hall, or to the cultural program proposed by a cultural center.

In the case of another embodiment variant, the information is sent by the transmit-receive portable device 3, particularly by the mobile telephone 4, to the user 1, via a tactile message produced by a tactile, mobile element 22, actuated by the mobile telephone 4.

A particular application of an embodiment variant of the present invention, in the case of an activatable transmit-receive portable device 3, used by the user 1 to proceed with active searches for information (I) inside the site, shall now be described, particularly by referring to FIG. 4. Most of the elements described are recognized by referring to FIGS. 1, 2 and 3. In this case, the transmit-receive portable device 3 comprises a control unit 23 actuatable by the user 1. The transmit-receive portable device 3 additionally comprises first data processing means 24 actuated by a control unit 23 for extracting and/or picking up the specific data from the chips 5. The result of the combination of the technical features is that, for example, the user 1, walking in a business center and having found a chip 5 associated with products that interest him, can receive, at his request, information (I) relative to the products, if need be, via a server 7.

A particular application of an embodiment variant of the present invention, in the particular case of a transmit-receive portable device 3, used by the user 1 to receive information (I) picked up over a broadcast, shall now be described by referring to FIG. 5. Most of the elements described are recognized by referring to FIGS. 1, 2 and 3. The transmit-receive portable device 3 comprises second data processing means 25 for extracting and/or automatically picking up the specific data from the chips 5 when the user 1 passes in proximity to these. The result of the combination of the technical features is that, for example, the user 1, walking in a business center, systematically receives information (I) relative to the products that are the subject of a business promotion and to which the chips 5 and their specific data were associated, at the time when he passes in proximity to the chips 5, if need be, via a server 7.

A particular application of an embodiment variant of the present invention, in the case where the system supplies information (I) relative to the contents of the site 2, shall now be described, by referring to FIG. 6. This embodiment variant pertains more particularly to the case in which the user 1 seeks predetermined information in a site 2. Most of the elements described are recognized by referring to FIGS. 1, 2 and 3. In the case of this variant, the transmit-receive portable device 3 additionally comprises first data entry means 26, and particularly a control unit 23 comprising a keyboard 29 or a voice operation 30, actuatable by the user 1, for entering data relative to the type of information that the user 1 seeks inside the site 2 in the transmit-receive portable device 3. The chips 5 contain specific data relative to the type of information accessible in the zones 43 in which the chips 5 are located. The transmit-receive portable device 3 comprises first detection means 32 for detecting and picking up the specific data from the chips 5 located in proximity to the user who has the transmit-receive device 3. The transmit-receive portable device 3 additionally comprises third sending means 33 for sending a message to the user 1, informing him that he is in a zone of the site 2, in which he may find the type of information that he seeks. The result of the combination of the technical features is that, for example, the user 1, entering a business center, may ask to receive, if need be, via an internet server 7, information on the products which are the subject of a business promotion, at the time when he passes in proximity to these.

Nomenclature

information (I)

user (1)

site (2)

mobile telephone transmit-receive portable device (3, 4)

chips (5)

server (7)

communication network (8)

first sending means (10)

database (12)

first transmission means (13)

computing means (14)

second communication means (15)

second sending means (16)

second computing means (19)

display screen (21)

tactile, mobile element (22)

control unit (23)

first data processing means (24)

second data processing means (25)

first data entry means (26)

loading and/or downloading means (27)

keyboard (29)

first detection means (32)

third sending means (33)

zones (43)

first receiving means (44)

second receiving means (48)

third receiving means (53)

remote activation means (63)

second transmission means (64)

converter (65)

integrated database (120)

1. Method for supplying information to a user at defined locations of a site; the user having a mobile telephone transmit-receive portable device; the method comprising:
the step, for the mobile telephone transmit-receive portable device, of receiving, from said chips arranged appropriately inside the site, data specific to the chips;
the contents of the information being correlated with the specific data in a database containing the information;
the method additionally comprising:
the step, for the mobile telephone transmit-receive portable device, of establishing, via a communication network a connection with a server, associated with the database,
the step, for the mobile telephone transmit-receive portable device, of communicating the specific data to the server, via the communication network,
the step, for the server of seeking the information, the contents of which are correlated with the specific data, in the database,
the step, for the server of transmitting the information, the contents of which are correlated with the specific data, to the mobile telephone transmit-receive portable device, via the communication network,
the step, for the mobile telephone transmit-receive portable device, of sending the information, the contents of which are correlated with the specific data, to the user;
so that the users has access to the information associated with said specific data of the chips, particularly located in proximity to the location of the user.

2. Method in accordance with claim 1; the information being sought in the database as a function of additional data supplied by the user.

3. Method in accordance with any of claims 1 or 2; the method additionally comprising the step, for the mobile telephone transmit-receive portable device, of loading and/or of downloading the information into a database integrated with the mobile telephone transmit-receive portable device.

4. Method in accordance with claim 3; the method additionally comprising the step, for the transmit-receive portable devices, of downloading the information, at at least one defined location of the site, into the database integrated with the portable device.

5. Method in accordance with claim 3; the method comprising the step, for the transmit-receive portable device, of additionally seeking, in the integrated database, the informational, the contents of which are correlated with the specific information received from the chips, and if need be, with the additional information.

6. Method in accordance with claim 5; the method additionally comprising the step, for the mobile telephone transmit-receive portable device, of sending the information, the contents of which are correlated with the specific data and, if need be, with the additional data, to the user.

7. Method in accordance with any of the claims 1 or 2; the method being such that the information is sent by the mobile telephone transmit-receive portable device to the user via a text and/or graphic and/or audio message.

8. Method in accordance with any of the claims 1 or 2; the method being such that the information is sent by the mobile telephone transmit-receive portable device to the user via a video message appearing on a display screen associated with the mobile telephone transmit-receive portable device.

9. Method in accordance with any of the claims 1 or 2; the method being such that the information is sent by the mobile telephone transmit-receive portable device to the user via a tactile message produced by a tactile, mobile element actuated by the mobile telephone transmit-receive portable device.

10. Method in accordance with any of the claims 1 or 2; the method comprising the step, for the user, of actuating a control unite of the mobile telephone transmit-receive portable device for extracting and/or picking up the specific data from the chips.

11. Method in accordance with any of the claims 1 or 2; the method comprising the step, for the mobile telephone transmit-receive portable device, of extracting and/or of automatically picking up the specific data from the chips when the user passes in proximity to these the chips.

12. Method in accordance with any of the claims 1 or 2; the method being more particularly intended to supply data relative to the site; the method additionally comprising:
the step, for the user, of entering data relative to the type of information that he is seeking inside the sited in the mobile telephone transmit-receive portable device,
the step, for the chips, of supplying specific data relative to the type of information accessible in zones in which the chips are located,
the step, for the mobile telephone transmit-receive portable device receiving the specific data from the chips located in proximity, of sending a message to the user, informing him that he is in a zone of the sites, in which he may find the type of information that he is seeking.

13. System for supplying information to a user at defined locations of a site; the system comprising:
a mobile telephone transmit-receive portable device placed at the disposal of a user;
the mobile telephone transmit-receive portable device comprising said first receiving means for receiving, from said chips arranged appropriately inside the site, data specific to the chips; the contents of the information being correlated with the specific data;
the system additionally comprising:
a database containing the information,
a server, particularly of the internet type, associated with the database,
the mobile telephone transmit-receive portable device comprising:
said first communication means for establishing a connection with the servers and the databases via a communication networks,
said first transmission means for communicating the specific data to the server via the communication networks;
the server comprising:
said first computing means for seeking the information, the contents of which are correlated with the specific data, in the database,
said second communication means for transmitting the information, the contents of which are correlated with the specific data, to the mobile telephone transmit-receive portable device via the communication network;
the mobile telephone transmit-receive portable device comprising said first sending means for sending the information, the contents of which are correlated with the specific data, to the user;
so that the user has access to the information associated with said specific data of the chips, particularly located in proximity to the location of the user.

14. System in accordance with claim 13; the information being sought in the database as a function of additional data supplied by the user.

15. System in accordance with any of claims 13 or 14; the mobile telephone transmit-receive portable device comprising an integrated database; said system additionally comprising said loading and/or downloading means for loading and/or downloading the information into the integrated database.

16. System in accordance with claim 15; said system additionally comprising said loading and/or downloading means for loading and/or downloading the information into the integrated database at least one defined location of the site.

17. System in accordance with any of the claim 15; the transmit-receive portable device comprising said second computing means for additionally seeking said information, the contents of which are correlated with the specific data received from the chips, and optionally, with the additional information, in the integrated database (120).

18. System in accordance with claim 17; the mobile telephone transmit-receive portable device additionally comprising said second sending means for sending said information from the integrated database, the contents of which are correlated with the specific data and, optionally, with the additional data, to the user.

19. System in accordance with any of the claims 13 or 14; the system being such that the information is sent by at least one of the first sending means and the second sending means of the mobile telephone transmit-receive portable device, to the user, via one of a text, graphic and audio message.

20. System in accordance with any of the claims 13 or 14; the system being such that the information is sent by at least one of the first sending means and the second sending means of the mobile telephone transmit-receive portable device, to the user, via a video message appearing on a display screen associated with the mobile telephone transmit-receive portable device.

21. System in accordance with any of the claims 13 or 14; the system being such that the information is sent by at least one of the first sending mean and the second sending means of the mobile telephone transmit-receive portable device, to the user, via a tactile message produced by a tactile, mobile element, actuated by the mobile telephone transmit-receive portable device.

22. System in accordance with any of the claims 13 or 14; the mobile telephone transmit-receive portable device comprising:
a control unit actuatable by the user,
said first data processing means actuated by the control unit for extracting and/or picking up the specific data from the chips.

23. System in accordance with any of the claims 13 or 14; the mobile telephone transmit-receive portable device comprising a second data processing means for extracting and/or for automatically picking up the specific data from the chips when the users passes in proximity to the chips.

24. System in accordance with any of the claims 13 or 14; the system being more particularly intended to supply data relative to the site; the system being such that the mobile telephone transmit-receive portable device additionally comprises a first data entry means, particularly a control unit comprising a keyboard, actuatable by the user, for entering data relative to the type of information that being sought by the user inside the site (2) in the mobile telephone transmit-receive portable device;
the mobile telephone transmit-receive portable device comprising:
first detection means for detecting and picking up the specific data, from the chips, relative to the type of information accessible in the zones in which the chips are located,
said third sending means for sending a message to the user, informing him that he is in a zone of the site in which he may find the type of information that he is seeking.

25. A server for supplying said information to a user at defined locations of a site; the server cooperating with a mobile telephone transmit-receive portable device, used by a user, for receiving, from said chips arranged appropriately inside the site, data specific to the chips; the contents of the information being correlated with the specific data in a database containing the information;
the server being associated with the database;
the server comprising connection means for establishing a connection with the mobile telephone transmit-receive portable device via a communication network;
the servers comprising:
second receiving means for receiving the specific data from the mobile telephone transmit-receive portable device, via the communication network;
said first computing means for seeking the information, the contents of which are correlated with the specific data, in the database,
second communication means for transmitting the information, the contents of which are correlated with the specific data, to the mobile telephone transmit-receive portable device via the communication network.

26. Server in accordance with claim 25; wherein the information being sought in the database is a function of additional data supplied by the user.

27. Mobile telephone transmit-receive portable device; the mobile telephone transmit-receive portable device, placed at the disposal of a user, being intended to supply, to the user, information contained in a database, at defined locations of a sites;
the mobile telephone transmit-receive portable device comprising:
first receiving means for receiving, from said chips arranged appropriately inside the site, data specific to the chips; the contents of the information being correlated with the specific data;
the mobile telephone transmit-receive portable device additionally comprising:
first communication means for establishing a connection with the database via a communication network,
first transmission means for communicating the specific data to a server associated with the database via the communication network;
third receiving means for receiving the information, the contents of which are correlated with the specific data, from the server via the communication networks;
first sending mean for sending the information, the contents of which are correlated with the specific data, to the user;
so that the user has access to the information associated with said specific data of the chips, particularly located in proximity to the location of the user.

28. Mobile telephone transmit-receive portable device in accordance with claim 27; the information being sought in the database as a function of additional data supplied by the user to the mobile telephone transmit-receive portable device.

29. Mobile telephone transmit-receive portable device in accordance with any of the claims 27 or 28; the mobile telephone transmit-receive portable device comprising a integrated database in which the information can be loaded and/or downloaded into the integrated database.

30. Mobile telephone transmit-receive portable device in accordance with claim 29; the mobile telephone transmit-receive portable device comprising a integrated database in which the information can be loaded and/or downloaded at least one defined location of the sites.

31. Mobile telephone transmit-receive portable device in accordance with claim 29; the transmit-receive portable device comprising a second computing means for additionally seeking, in the integrated database, the information, the contents of which are correlated with the specific information received from the chips, and optionally, with the additional information.

32. Mobile telephone transmit-receive portable device in accordance with claim 31; the mobile telephone, transmit-receive portable device additionally comprising a second sending means for sending the information from the integrated database, the contents of which are correlated with the specific data and, optionally, with the additional data, to the user.

33. Mobile telephone transmit-receive portable device in accordance with any of the claims 27 or 28; wherein the information is sent by the first sending means and/or the second sending means of the mobile telephone transmit-receive portable device, to the user, via one of a text, graphic and audio message.

34. Mobile telephone transmit-receive portable device in accordance with any of the claims 27 or 28; wherein the information is sent by the first sending means and/or the second sending means of the mobile telephone transmit-receive portable device, to the users, via a video message appearing on a display screen associated with the mobile telephone transmit-receive portable device.

35. Mobile telephone transmit-receive portable device in accordance with any of the claims 27 or 28; wherein the information is sent by the first sending means and/or the second sending means of the mobile telephone transmit-receive portable device, to the user, via a tactile message produced by a tactile, mobile element, actuated by the mobile telephone transmit-receive portable device.

36. Mobile telephone transmit-receive portable device in accordance with any of the claims 27 or 28; the mobile telephone transmit-receive portable device comprising:
a control unit actuatable by the user,
a first data processing means actuated by the control unit for extracting and/or picking up the specific data from the chips.

37. Mobile telephone transmit-receive portable device in accordance with any of the claims 27 or 28; the mobile telephone transmit-receive portable device comprising second data processing means for extracting and/or for automatically picking up the specific data from the chips when the user passes in proximity to the chips.

38. Mobile telephone transmit-receive portable device in accordance with any of the claims 27 or 28; the mobile telephone transmit-receive portable device being more particularly intended to supply data relative to zones of the site; the mobile telephone transmit-receive portable device additionally comprising said first data entry means, particularly a control unit comprising a keyboard, actuatable by the user, for entering data relative to the type of information that he is seeking inside the site in the mobile telephone transmit-receive portable device;
the mobile telephone transmit-receive portable device comprising:
first detection means for detecting and picking up the specific data, from the chips, relative to the type of information accessible in the zones in which the chips are located,
third sending means for sending a message to the user, informing him that he is in one of the zones of the site in which he may find the type of information that he is seeking.

39. Chip for supplying said information to a user at defined locations of a site; the chip being intended to be arranged appropriately inside the site; the chip containing specific data; the contents of the information being correlated with the specific data; the specific data being intended to be picked up by a mobile telephone transmit-receive portable device used by the user; the mobile telephone transmit-receive portable device comprising said first sending means for sending the information, the contents of which are correlated with the specific data, to the user.

40. Chip in accordance with claim 39; the mobile telephone transmit-receive portable device comprising means for remote activation of the chip; the chip comprising said second transmission means, transmitting the specific data when it is activated by the mobile telephone transmit-receive portable device.

41. Chip in accordance with claim 40; the mobile telephone transmit-receive portable device comprising a control unit, actuatable by the user and triggering the means for remote activation of the chip.

42. Chip in accordance with any of the claims 39 through 41; the chip comprising an energy source, providing operational power to the second transmission means.

43. Chip in accordance with claim 42; the energy source consisting of a converter for converting electromagnetic energy and/or of light energy into electrical power.

44. Chip in accordance with claim 43; the electromagnetic energy or light energy being supplied by the mobile telephone transmit-receive portable device via infrared radiation.
